(19) United States
(12) Patent Application Publication
(10) Pub. No.: US 2011/0117773 A1
(43) Pub. Date: May 19, 2011

(54) AIRCRAFT CONNECTOR ASSEMBLY

(76) Inventor: Eric Delmas, Brax (FR)

(21) Appl. No.: 11/718,836

(22) PCT Filed: Oct. 13, 2005
(86) PCT No.: PCT/FR2005/050851

§ 371 Date: Oct. 5, 2007

(30) Foreign Application Priority Data
Nov. 8, 2004 (FR) 0452562

(51) Int. Cl. H01R 13/73

(52) U.S. Cl. 439/544

(57) ABSTRACT

The invention relates to a connector assembly (1, 100) for connecting a motor to the cable (5,103) of a strut fixing the motor to an aircraft wing. A male part (2, 101) includes pins (7, 107) and female part (3, 102) lugs (10, 108). In an embodiment, the pins extend radially around the axis (A) of a cable (5) provided with the pins. In another embodiment, the pins extend in a parallel position to the axis (A′) of the cable (103) provided therewith and in a perpendicular direction with the cable provided therewith.

The invention falls into the field of electric connectors. The purpose of the invention is a connector assembly capable of embodying a connection between an aircraft engine and a cable, or other electric component, located in a hooking mast. The hooking mast enables to integrate the engine with the aircraft's wings. The invention especially finds applications in the field of aeronautics, for the purpose of assembly in aircraft equipped with a fire-resistant zone between the engine and an aircraft fuselage.

A purpose of the invention is to supply a connector assembly enabling to easily connect and disconnect an aircraft engine from a cable located in a body of a mast, the said mast supporting the said engine, in order to link the engine to an electric generator located in an aircraft's fuselage. Another purpose of the invention is to supply such a connector assembly of compact size. An additional purpose of the invention is to supply such a connector assembly capable of acting as a firewall.

An aircraft is generally equipped with at least two engines. Each engine is thus integrated with the lower camber of a wing of the said aircraft. The engine is integrated with the wing through the intermediary of a hooking mast. The hydraulic circuits for the fuel, the hot air and the pressure and temperature exchangers transit from the aircraft body up to the engine, passing through the mast. Likewise, an electric cable transits from the engine up to the aircraft, passing through the mast, in order to link the said engine to an electric generator.

In order to facilitate the engine's maintenance by enabling to easily separate the said engine from the hooking mast, it is known to use a connector assembly between the engine and the mast. The connector assembly enables to connect a cable coming from the engine with a cable coming from the mast, the cable coming from the mast being linked, by a tip opposite the tip connected to the engine's cable, to the electric generator. Such connector assembly is easily accessible as it is located on the outside of the aircraft, in the position of the lower camber of a wing. Hence, in order to separate the engine from the aircraft, the engine's cable in the mast can be disconnected, thus enabling to isolate the said engine. It is thus possible, without any risk of electrocution in particular, to service or exchange engines, etc.

Furthermore, in order to increase an aircraft's safety, it is known to separate, by way of a fire-resistant zone, the engine and the body of the aircraft. Generally, the fire-resistant zone is located in the position of a separating partition, or a firewall partition, between the engine and the mast. The firewall partition can be an integral part of the mast. Any passage through such firewall partition, namely by the electric cable linking the engine to the electric generator, must hence be made safe in order to prevent any possible propagation of flames.

In order to reduce the overall size and weight where the engine and mast are positioned, though enabling easy maintenance of the said engine and increased safety in terms of fire propagation, it is known to use a connector assembly located in the position of the firewall partition. Thus the connector assembly alone acts as a firewall in the position of the cable.

Such a connector assembly is equipped with a receptacle, integral with the firewall partition. The receptacle supports the cable's contacts coming from the electric generator which transits through the mast. The receptacle is capable of being connected to another element of the connector assembly by way of a free tip on the engine's cable. The receptacle comprises, for example, four spikes creating the male contacts, which slot into the housings fitted on the free tip of the engine's cable, such housings creating the female contacts. The dimensions of the housings are such that the spikes can be inserted with force into the said housings and are thus held in place through the tight contact inside the said housings. The connector assembly can be equipped with three electric generation phases and one neutral phase. In order to act as the connector assembly firewall, the receptacle can be equipped, for example, with material capable of preventing the possible propagation of flames. The firewall materials generally used are rubber or silicon.

Such connector assembly thus enables, without significantly increasing the overall dimensions and the weight in the engine/mast liaison position, to ensure a reversible fitting of the engine onto the mast, in addition to a firewall role.

Nevertheless, such a connector assembly often causes problems. Indeed, the engine, especially when in operation, is subjected to numerous and severe vibrations. Such vibrations are especially conveyed to the connector assembly. The spikes thus undergo wear due to their rubbing against the walls of the housings in which they are inserted. The spikes can be spikes made of bronze and coated in a fine layer of gold. Such layer of gold is eliminated over time due to the repeated rubbing of the spikes against the walls of the housings. The spikes may then undergo corrosion, namely due to the dampness in the air. Nevertheless, the strength running through the connector assembly is approximately 200 Amperes per electric phase. Due to the corrosion, a resistance is created, causing a localised temperature increase in the zone of the spikes having undergone such corrosion. Such increase in temperature can cause the formation of electric arcs which may permanently damage one or several electric phases of the connector assembly.

In the invention, the aim is to resolve the above problem by proposing a connector assembly capable of embodying a safe connection between an engine and a cable located in an aircraft's mast. By safe connection is meant that the connection is capable of resisting to corrosion. The connection can further fill the role of firewall. The connector assembly of the invention has similar dimensions to those of the connector assembly of the prior art described above. Hence, it is possible to equip aircraft in service with the connector assembly of the invention without having to undertake prior major alterations of the connection's configuration.

In order to achieve such result, the connector assembly of the invention comprises a male part, fitted with spikes, and a female part, fitted with terminal lugs. Each spike creates a male contact, capable of crossing a terminal lug creating a female contact. The connection is made on the separating partition, between the engine and the mast. The part of the connector assembly passing through the said partition can be equipped with firewall materials. A spike can be secured inside a terminal lug using, for example, a bolt. Hence, all risk of movement relating to the spike with regard to the terminal lug shall be removed. The spikes can no longer be worn out through rubbing. If the spikes are coated with gold or other substance, such coating is no longer eliminated due to the rubbing of the spike against the terminal lug. The effects of corrosion are thus also removed or at least vastly reduced.

The terminal lugs are independent from each other, i.e. each one forms a tip of an isolated conductor with all the conductors being wrapped in, for example, a sheath for the purpose of forming a cable. The connection is made by undertaking as many steps as the number of existing contacts, i.e. each step consists of connecting a spike to a terminal lug. Connection between the engine and the mast is made easy, just like its disconnection. It is possible to make a vast number of connections and disconnections without any risk of wear, while the connector assembly of the prior art automatically creates, in the long term, certain wear due to the fact of forcing the spikes inside the housings.

The purpose of the invention is thus a connector assembly capable of establishing a connection between an engine and a cable of a mast, the said mast fixing the engine to a wing of an aircraft, the connector assembly being located in the position of a separating partition between the engine and the mast, the said connector assembly comprising a male part supporting male contacts, and a female part supporting female terminal lugs, the male contacts capable of being connected to the female contacts, characterised in that the male contacts are spikes and the female contacts are terminal lugs.

In an embodiment example, the connector assembly is equipped with a firewall nucleus. The firewall nucleus is able to form a core of the male part and/or the female part of the said assembly. The firewall nucleus can be a nucleus in silicon or in rubber. Hence, it is not necessary to equip the aircraft, in the position of the engine/mast electric link, with an additional device for embodying the required firewall role.

According to a first embodiment example of the invention's connector assembly, the spikes extend in a radial manner in relation to an axis of a cable supporting the said spikes.

According to a second embodiment example of the connector assembly, the spikes extend in parallel to an axis of a cable supporting the said spikes, the said terminal lugs extending in a radial manner in relation to a cable supporting the said terminal lugs.

By cable of a mast is meant at least an electric conductor passing through the mast. It is possible to have a plurality of electric conductors, all these electric conductors being able to be wrapped, at least partially, in a common sheath. Likewise, by cable of an engine is meant at least an electric conductor linked electrically to the engine. In the event of there being a plurality of electric conductors, the latter can be at least partially wrapped in a common sheath.

It is also possible to embody the terminal lugs in a flexible material. No importance is thus given to a design and a direction of the spikes, since the flexibility of the terminal lugs enables to ensure connection in all cases.

In an embodiment example, the connector assembly's cable fitted with terminal lugs is located on the engine side, the cable fitted with the spikes being located on the mast side. Hence, the female part of the connector assembly is only mobile in this direction when the engine is separated from the mast, the said female part also being separated from the mast. The male part itself is fixed to the separating partition through which passes the cable supporting the said male part.

In order to ensure that the spikes are held in their respective terminal lug, it is possible to plan means for fixing a terminal plug to a spike. In an embodiment example, the means for fixing are comprised of bolts.

The connector assembly of the invention can be triple phase. It can further include at least one neutral phase.

The invention will be better understood after reading the following description and studying the figures attached hereto. These are shown as examples and are not to be considered as complete with regard to the invention. The figures show:

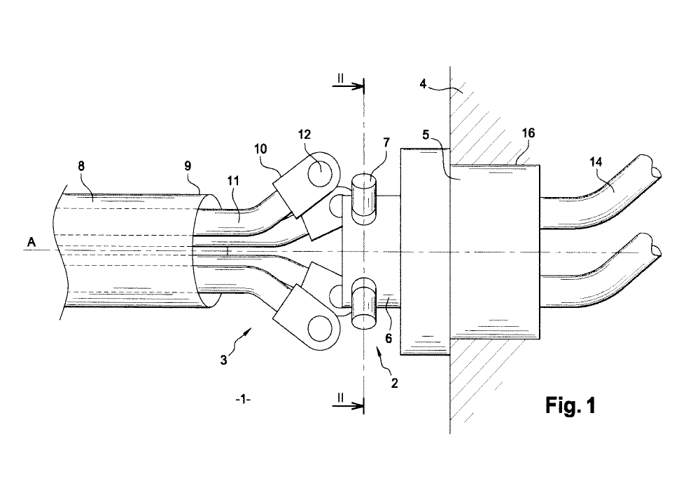

FIG. 1: A side view of a connector assembly, according to a first embodiment example;

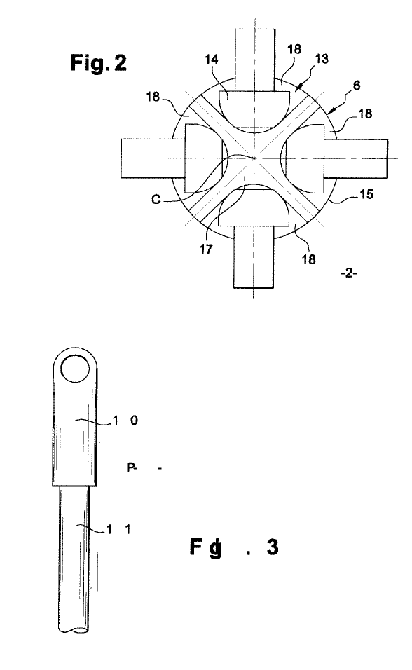

FIG. 2: A cross-section, according to II-II of FIG. 1;

FIG. 3: A terminal lug according to an embodiment example of the invention;

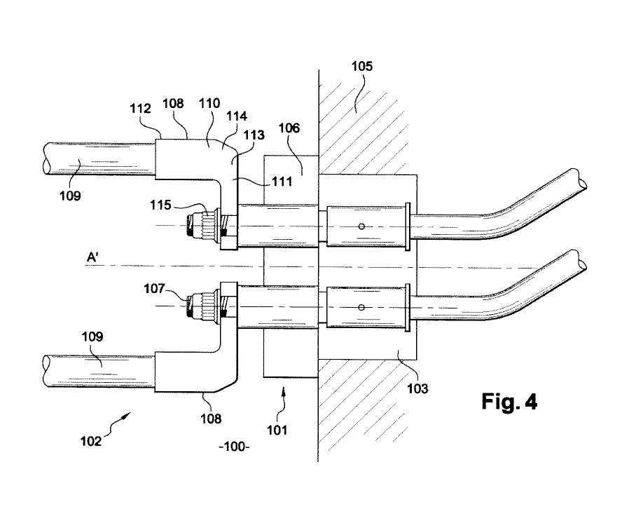

FIG. 4: A side view of a connector assembly, according to a second embodiment example.

FIG. 1 illustrates a male part 2 and a female part 3, not connected, of a connector assembly 1.

A first cable 5 transits within a mast and passes through a separating partition 4 between the said mast and an engine of an aircraft (not illustrated), in order that the male part 2 of the connector assembly 1, supported by the first cable 5, emerges in the direction of the outer part of the mast, towards the engine. The male part 2 is fixed onto the separating partition 4. The male part 2 of the connector assembly 1 is fitted with a connection head 6 projecting from the separating partition 4. The connection head 6 support the male contacts 7. The male contacts 7 are spikes. The spikes extend in a radial manner in relation to a longitudinal A axis of the first cable 5, projecting from the connection head 6.

A second cable 8 is fitted with female contacts 10 in the position of a free tip 9. The free tip 9 of the second cable 8 and the female contacts 10 form the female part 3 of the connector assembly 1. A fixed tip (not illustrated) of the second cable 8, opposite the free tip 9, is integral with the engine. The female contacts 10 are terminal lugs. Each terminal lug 10 forms the tip of a conductor 11, the conductor assembly 11 being wrapped in a sheath and forming the second cable 8. By terminal lug 10 is meant a metal piece fixed to the tip of an electric conductor 11 in order to allow its connection, the terminal lug 10 thus comprising an orifice 12 or a notch. The terminal lugs 10 of the female part 3 of the connector assembly 1 are thus each one equipped with an orifice 12. A spike 7 is able to be passed through each orifice 12 in order to embody a connection between the first cable 6 and the second cable 8. The terminal lugs 10 are flat terminal lugs. By flat terminal lug 10 is meant that a body of each terminal lug 10 extends along a single plane P (FIG. 3).

In order to connect the female part 3 to the male part 2, the second cable 8 is brought towards the separating partition 4. It is then possible to attach the terminal lugs 10 to the spikes 7. In order to do so, each spike 7 is inserted into an orifice 12 of a terminal lug 10 in order to embody an electric connection between spike 7 and terminal lug 10, and hence between the engine and the first cable 6 transiting through the mast.

In order to hold the spikes 7 in the terminal lugs, whatever the conditions of use for the connector assembly 1, it is possible to equip the said connector assembly 1 with means for fixing one or several terminal plugs 10 onto their respective spike 7. Hence, each terminal lug 10/spike 7 combination can be equipped with such fixing means. Even in cases of the engine severely vibrating, the spikes 7 still remain integral with the terminal lugs 10.

FIG. 2 illustrates a cross-section, according to the II-II axis, of the male part 2 of the connector assembly 1 of FIG. 1. The connection head 6 is of a cylindrical circular shape and comprises, with an internal volume 13, four electric conductors 14. The electric conductors 14 extend in parallel to each other and in parallel to the A axis. Each electric conductor 14 is equipped with a spike 7 which extends perpendicular to its electric conductor 14, projecting from the said conductor 14. The spikes 7 extend toward the outer part in relation to a centre C of the connection head 6, in order to pass through the wall 15 of the said connection head 6 and to emerge in the direction of the outer part of the internal volume 13. The electric conductors 14 can be (FIG. 1), at least partially, wrapped in a sheath 16, enabling to form the first cable 5. Once they have passed through the separating partition, the conductors can then be isolated once again, such as illustrated in FIG. 1.

In an example represented in FIG. 2, the connection head 6 is equipped, within its internal volume 13, with a firewall nucleus 17. The firewall nucleus 17 is cross-shaped and thus divides the internal volume 13 into four comportments 18. Each compartment 18 comprises an electric conductor 14. In an embodiment example, silicon or rubber is used to embody the firewall nucleus 17. Hence, the electric conductors 14 are electrically isolated one from another.

In the example represented in FIGS. 1 and 2, the spikes 7 emerge directly in the direction of the outer part, i.e. they are not protected by any receptacle. Such exposure to the ambient air and to bad weather does not give rise to any problems insofar as the said spikes 7 are coated with a substance resistant to corrosion, such as a coating of gold. Indeed, the risks of wear being removed or severely reduced, the coating of gold is no longer eliminated over time, thus preventing occurrence of the corrosion phenomena.

Nevertheless, in other embodiment examples of the connector assembly 1 of the invention, it is possible to equip the connection head 6 with a protection. For example, the connection head 6 is surrounded by a cylindrical circular wall of a larger diameter than a diameter of the said connection head 6, and of a height at least equal to a height of the connection head 6. By height is meant the dimension of the projection or of the connection head 6, which extends in parallel to the A axis. Thus the spikes 7 are wrapped and protected by such protection. Furthermore, the connection in itself, between the spikes 7 and the terminal lugs 10, is protected by this wall.

The male 7 and female 10 contacts of the example shown in FIGS. 1 and 2 represent a total of four. For example, three spikes 7 connected to three terminal lugs 10 form three electric phases, the fourth spike, connected to the fourth terminal lug 10, forming a neutral phase. It is also possible to have four electric phases, or two electric phases and two neutral phases, or one electric phase and three neutral phases. Likewise, it is possible to embody a connector assembly 1 equipped with more or less spikes 7 and terminal lugs 10, in accordance with the needs.

FIG. 3 illustrated a tip of an electric conductor 11 of the female part 2 of the connector assembly 1. The tip of the electric conductor 11 supports a terminal lug 10. The terminal lug 10 extends in continuation of the electric conductor 11. The terminal lug 10 is a flat terminal lug and is contained within a single plane.

It is possible to embody the terminal lug 10 in flexible conductor material. Thus, it is possible to bend and/or twist the said terminal lug 10. The terminal lug 10 then extends in several different planes, according to the bends and/or twists imposed on the said terminal lug 10. A connector assembly 1 fitted with flexible terminal lugs 10 can be useful should the spikes 7 of the male part 2 of the connector assembly 1 not be easily accessible, or should an available length of the electric conductors 11 supporting the terminal lugs be hardly adequate. By available length is meant the length of an electric conductor 11 not wrapped in the sheath, and thus isolated in relation to the other electric conductors 11 of the second cable 8 (FIG. 1).

FIG. 4 illustrates a connector assembly 100 according to another embodiment example of the invention. The connector assembly 100 comprises a male part 101 and a female part 102.

The male part 101 forms a tip of a first cable 103, while the female part 102 forms a tip of a second cable (not illustrated). The first cable 103 passes through a separating partition 105 between a mast and an aircraft's engine (not illustrated) in order to transit within the said mast up until, for example, an electric generator located inside an aircraft. The male part 101 is integral with the separating partition 105 through which it passes. The male part 101 of the connector assembly 100 is fitted with a connection head 106 projecting from the separating partition 105. Male contacts 107 emerge from this connection head 106. The male contacts 107 are spikes which extend in parallel to a longitudinal A′ axis of the first cable 103.

The female part 102 of the connector assembly 100 is fitted with female contacts 108 formed by the terminal lugs. Each terminal lug 108 forms the tip of a conductor 109 of the second cable.

In the example illustrated in FIG. 4, the male 101 and female 102 parts of the connector assembly 100 are connected. In order to do so, each terminal lug 108 is integral with a spike 107. Each spike 107 passes through an orifice (not visible) of a terminal lug.

The terminal lugs 108 are equipped with two segments 110 and 111, integral with each other. A first segment 110 shall become integral by way of a first tip 112 of the electric conductor 109, and extends along a same plane as the said conductor 109. A second segment 111 is integral by way of a first tip 113 of a second tip 114 of the first segment 110. The second tip 111 extends perpendicular to the first segment 110. The second segment 111 is equipped with the orifice through which the spike 107 passes through the terminal lug 108.

The spikes 107 are held on the terminal lugs 108 using the means for fixing. In the example illustrated, the fixing means 115 are the bolts. The spikes 107 are then equipped with threading enabling to screw each bolt 155 around a spike 107. The bolts 115, when they are correctly screwed, prevent any movement from the spikes 107 inside the orifice of the corresponding terminal lugs 108. Thus we remove the risk of the spikes 107 rubbing against the wall of the orifices set into the lugs 108.

In another embodiment example, the spikes 107 can be equipped with an orifice in which is inserted a blocking rod forming the means for fixing 115. The length of the blocking rod shall strictly exceed a diameter of the equipped orifice on the terminal lug 108. By length of rod is meant the largest measurement of the said rod. Thus the rod prevents any accidental removal of the spike 107.

In another embodiment example of a connector assembly 1 or 100 or the invention, it is possible to equip the tip of the cable coming from the engine with a male part equipped with spikes, the tip of the cable passing through the separating wall between the mast and the engine is thus equipped with a female part comprising terminal lugs.

1. A connector assembly for aircraft, capable of establishing a connection between an engine and cable of an engine's fixing mast to an aircraft's wing, the connector assembly being located in the position of a separating partition between the engine and the mast, the said connector assembly comprising a male part supporting male contacts, and a female part supporting female contacts, the male contacts capable of being connected to the female contacts, wherein the male contacts are spikes and the female contacts are terminal lugs, each spike being capable of passing through the terminal lug.

2. A connector assembly according to claim 1, further comprising a firewall nucleus forming a core of the male part and/or of the female part of the said connector assembly.

3. A connector assembly according to claim 2, wherein the firewall nucleus is a nucleus made of silicon.

4. A connector assembly according to claim 2, wherein the firewall nucleus is a nucleus made of rubber.

5. A connector assembly according to claim 1, wherein the spikes extend in a radial manner in relation to a longitudinal axis (A) of a cable supporting the said spikes.

6. A connector assembly according to claim 1, wherein the spikes extend in parallel to a longitudinal axis (A′) of a cable supporting the said spikes, the terminal lugs extending perpendicular in relation to a cable supporting the said terminal lugs.

7. A connector assembly according to claim 1, wherein the terminal lugs are made in flexible material.

8. A connector assembly according to claim 1, wherein the cable fitted with female part of the connector assemble is located on the engine side, the cable fitted with the spikes being located on the mast side.

9. A connector assembly according to claim 1, wherein it comprises means for fixing a terminal lug to a spike.

10. A connector assembly according to claim 9, wherein the fixing means are comprised of bolts.

11. A connector assembly according to claim 1, wherein it is triple phased.
